(19) United States
(12) Patent Application Publication
(10) Pub. No.: US 2010/0064883 A1
(43) Pub. Date: Mar. 18, 2010

(54) Compact modular wireless control devices

(76) Inventor: Deshko Gynes, Los Angeles, CA (US)

Correspondence Address: Benman, Brown & Williams, Suite 2740, 2049 Century Park East, Los Angeles, CA, 90067, US

(21) Appl. No.: 12/583,732

(22) Filed: Aug. 25, 2009

Related U.S. Application Data
(63) Continuation-in-part of application No. 12/157,563, filed on Jun. 10, 2008.
(60) Provisional application No. 61/091,989, filed on Aug. 26, 2008.

(51) Int. Cl. G10H 7/00

(52) U.S. Cl. 84/645

(57) ABSTRACT

A modular controller system. The novel modular controller system includes a plurality of control modules, each module including a plurality of controls; a first mechanism for mechanically connecting the control modules; a second mechanism for communicating with a mobile device; and a program stored in and executed by the mobile device for receiving data from the control modules and in accordance therewith generating output data. In a preferred embodiment, the system includes a docking module for holding and interfacing with the mobile device, and the docking module and control modules each include a housing having physical features for mechanically connecting the modules together and electrical connectors in the physical features for transferring data and power between modules. The program generates output data in response to the data received from the control modules to control an application running on the mobile device.

### CROSS-REFERENCE TO RELATED APPLICATIONS

This application is a continuation-in-part of U.S. patent application Ser. No. 12/157,563, entitled MODULAR MIDI CONTROLLER filed Jun. 10, 2008, by D. Gynes (Atty. Docket No. Gynes-1) and claims the benefit of U.S. Provisional Application No. 61/091,989, filed Aug. 26, 2008, the disclosure of which is hereby incorporated by reference.

### BACKGROUND OF THE INVENTION

1. Field of the Invention

The present invention relates to electronics. More specifically, the present invention relates to computer application controllers and MIDI (Musical Instrument Digital Interface) controllers.

2. Description of the Related Art

MIDI (Musical Instrument Digital Interface) is a protocol that enables electronic musical instruments to interact with each other or with a computer or other electronic equipment. The MIDI data format is comprised of a series of event messages, such as “note on” and “note off” messages for indicating when a musical note should be played and at what pitch and intensity, and “control change” messages for controlling effects such as volume, vibrato, tempo, modulation, pan, sustain, reverb, etc. The MIDI signal is therefore not an audio signal, but digital message data that can be converted to an audio signal by a synthesizer or other sound generator. MIDI messages can also be used to control other types of MIDI compatible electronics such as lighting and visual effects.

A MIDI system typically includes a MIDI controller and a sound generator. A MIDI controller, which typically includes a musical keyboard or other tactile controls for interacting with a user, generates MIDI messages from user inputs and transmits the MIDI data to the sound generator. The sound generator, which may be a computer running synthesizing software or a stand-alone synthesizer, converts the MIDI data to an audio signal that can be played through a loudspeaker.

There are several different types of MIDI controllers, each designed for a particular application or type of user. For example, controllers for controlling note on/off messages (including pitch/timbre and/or intensity parameters) are typically designed to emulate conventional musical instruments and include musical keyboards (similar to a piano) and drum pads. Controllers typically used for controlling effects include sliders, knobs, faders, buttons, switches, pitch bend wheels, modulation wheels, etc.

Conventional MIDI controllers typically include several individual controls and are available in a variety of different sizes, types, and configurations. A user can typically find a controller that is well suited for one particular application; however, it may be difficult or impossible to find a product that is suitable for several different types of applications. For example, a user may use a controller with a full-sized keyboard when composing a song or recording parts for melodic instruments, switch to a controller with several drum pads for playing a rhythm section, and then switch to a controller with several sliders and knobs when mixing and adding audio effects to a composition. The user may also want a smaller portable controller with a smaller keyboard and a few sliders and knobs for controlling audio and visual effects while performing at a live show. With currently available MIDI devices, the user needs to buy a different product for each application. This can become prohibitively expensive and the multiple controllers can occupy a large amount of space, which is typically very limited in a studio environment. Currently, there is no single MIDI controller that can be reconfigured to meet the requirements of different applications.

Hence, a need exists in the art for a MIDI controller that can be reconfigured for various applications.

### SUMMARY OF THE INVENTION

The need in the art is addressed by the modular controller system of the present invention. The novel modular controller system includes a plurality of control modules, each module including a plurality of controls; a first mechanism for mechanically connecting the control modules; a second mechanism for communicating with a mobile device; and a program stored in and executed by the mobile device for receiving data from the control modules and in accordance therewith generating output data. In a preferred embodiment, the system includes a docking module for holding and interfacing with the mobile device, and the docking module and control modules each include a housing having physical features for mechanically connecting the modules together and electrical connectors in the physical features for transferring data and power between modules. The program generates output data in response to the data received from the control modules to control an application running on the mobile device.

### BRIEF DESCRIPTION OF THE DRAWINGS

FIG. 1 is a top view of a modular controller system designed in accordance with an illustrative embodiment of the present teachings, showing an illustrative horizontal configuration.

FIG. 2 is an isometric view of an individual control module designed in accordance with an illustrative embodiment of the present teachings.

FIG. 3a is a simplified diagram of a docking module 16 designed in accordance with an illustrative embodiment of the present teachings.

FIG. 3b is a simplified diagram of an alternative docking module designed in accordance with an illustrative embodiment of the present teachings.

FIG. 4 is a top view of a brain module designed in accordance with an illustrative embodiment of the present teachings.

FIG. 5 is a top view of modular controller system designed in accordance with an illustrative embodiment of the present teachings, showing an illustrative vertical configuration.

FIG. 6 is an exploded view showing two control modules and a hinge apparatus designed in accordance with an illustrative embodiment of the present teachings.

FIG. 7a is an isometric view of a modular controller system designed in accordance with an illustrative embodiment of the present teachings, showing an illustrative vertical configuration connected via hinges.

FIG. 7b is a side view of the modular controller system of FIG. 7a.

FIG. 7c is an isometric view of the modular controller system of FIG. 7a closed and folded into a compact shape.

FIG. 8a is a back view of a control module designed in accordance with an illustrative embodiment of the present teachings.

FIG. 8b is a side view of a controller system designed in accordance with an illustrative embodiment of the present teachings.

FIG. 9a is an isometric view of a control module with USB connectors designed in accordance with an illustrative embodiment of the present teachings.

FIG. 9b is an isometric view of a control module with USB connectors designed in accordance with an illustrative embodiment of the present teachings.

FIG. 9c is an isometric view of a detachable USB connector designed in accordance with an illustrative embodiment of the present teachings.

FIG. 9d is a close up view of a module with a detachable USB connector designed in accordance with an illustrative embodiment of the present teachings.

FIG. 9e is a close up view of a module with a detachable USB connector designed in accordance with an illustrative embodiment of the present teachings.

FIG. 10 is a top view of a modular controller system with a wireless network adapter designed in accordance with an illustrative embodiment of the present teachings.

FIG. 11 is a simplified block diagram of a modular controller system designed in accordance with an illustrative embodiment of the present teachings.

FIG. 12 is a simplified flow chart of a module driver designed in accordance with an illustrative embodiment of the present teachings.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The present invention provides a novel controller system having a unique modular design that allows a user to reconfigure the system as desired, changing the types and numbers of controls in the system as well as its overall size and shape. In a preferred embodiment, the controller system is compact and portable, and designed to interact with a mobile device such as a cellular phone.

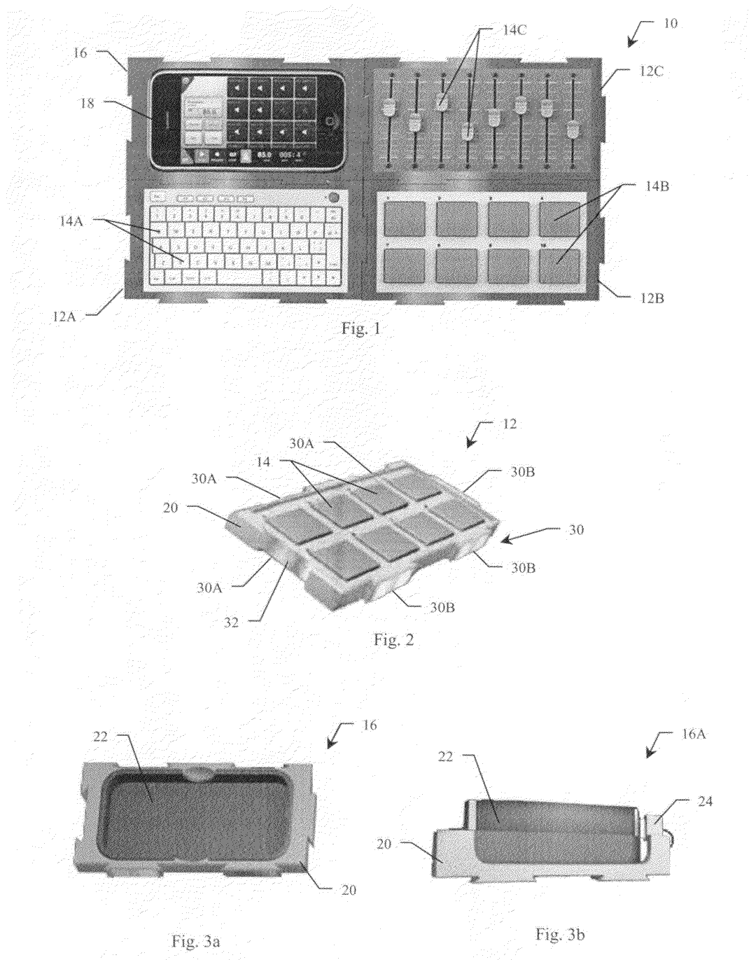

FIG. 1 is a top view of a modular controller system 10 designed in accordance with an illustrative embodiment of the present teachings, showing an illustrative horizontal configuration. The novel controller system 10 includes a plurality of control modules 12 that are connected together to form one unit 10.

FIG. 2 is an isometric view of an individual control module 12 designed in accordance with an illustrative embodiment of the present teachings. Each module 12 includes a plurality of individual tactile controls 14 for interfacing with a user. The individual controls 14 may include, for example, keys (on a musical keyboard or QWERTY keyboard), pads, buttons, sliders, knobs, wheels, ribbons, trackballs, touchscreens, etc. Each control 14 converts a mechanical action by the user (such as depressing a key or turning a knob) into an electrical signal. As described more fully in the above-identified parent application, in a preferred embodiment, each module 12 includes a processor that converts the electrical signals from the controls 14 to encoded controller data, which includes digital messages, that indicate when a particular control 14 is activated or deactivated and any parameters associated with the control 14 such as how hard a key is depressed or how much a knob is turned. Thus, in the preferred embodiment, the output of each module 12 is the digital message data, not the raw electrical signals from the controls 14.

Several different types of modules 12 with different types of controls 14 are available for the controller system 10. For example, in FIG. 1, the controller system 10 includes three different control modules 12: a first module 12A with a QWERTY keyboard 14A, a second module 12B with several drum pads 14B, and a third module 12C with several faders 14C.

The controller system 10 also includes a primary device for receiving the data from each of the control modules 12, decoding the received data and encoding it in a desired format, and sending the encoded data to the application being controlled (which may be, for example, a software application running on the same primary device, or a MIDI instrument or sequencer). In a preferred embodiment, the primary device is a mobile device 18 such as a cellular phone having a processor capable of running audio applications.

As shown in the illustrative embodiment of FIG. 1, the controller system 10 includes a docking module 16 for holding and interfacing with a mobile device 18, such as a smart phone (as shown in FIG. 1) or other cellular phone, multimedia player, portable video game player, etc.

FIG. 3a is a simplified diagram of a docking module 16 designed in accordance with an illustrative embodiment of the present teachings, and FIG. 3b shows an alternative docking module 16A designed in accordance with an illustrative embodiment of the present teachings. Each docking module 16, 16A includes a module housing 20 having a slot 22 adapted to hold a mobile device 18 (not shown in FIGS. 3a and 3b), and an interface for communicating with the device 18. The docking module 16, 16A may include a wired data connector 24 that plugs into a mating connector on the device 18 (as shown in FIG. 3b). Alternatively, the docking module 16, 16A may include an internal wireless transceiver for communicating with the mobile device 18 wirelessly using, for example, a Bluetooth connection or other communication protocol. The docking module 16, 16A may also include electronics for charging the internal battery of a connected mobile device 18.

In a preferred embodiment, the mobile device 18 acts as the primary device of the system 10, and includes module driver software for receiving the data from each of the control modules 12, decoding the received data, and using the data to control a software application running on the device 18. Alternatively, the primary device may be a laptop computer or desktop computer running the module driver software, or the system 10 may include a “brain” module, which acts as the primary device.

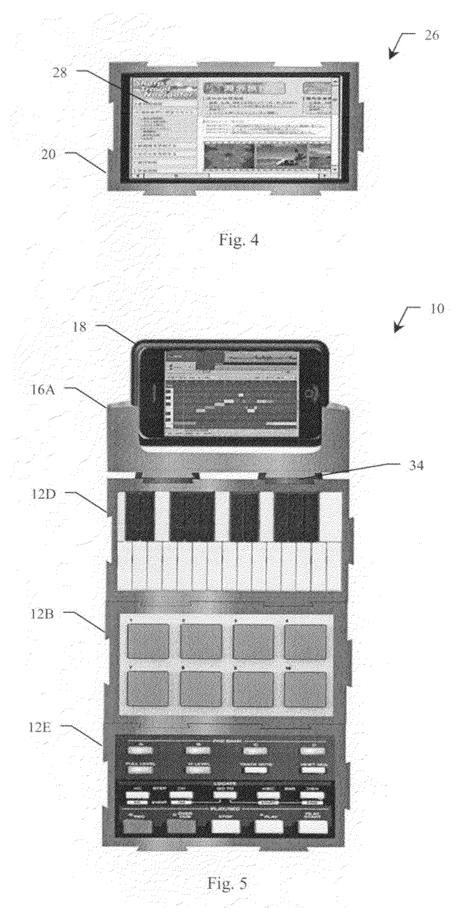

FIG. 4 is a top view of a brain module 26 designed in accordance with an illustrative embodiment of the present teachings. The brain module 26 is a processing module that receives and decodes the signals from the control modules 12. The brain module 26 may also be adapted to run application software (such as audio processing software) that uses the decoded data. Alternatively, the brain module 26 may encode the data using a protocol (such as MIDI) used by an external device (such as a MIDI instrument or sequencer) and output the encoded data to the external device.

As described more fully in the above-identified parent application, the brain module 26 includes a processor adapted to receive the data from each module 12 and combine and process the data to generate an output that can be used by the application being controlled. The brain module 26 may also include a user interface such as a touchscreen 28 for communicating with the user. The brain module 26 may also be configured to provide additional control data by, for example, using virtual controls displayed on the touchscreen 28. Thus, the brain module 26 can function independently as a small controller (without the other modules 12).

As shown in FIG. 2, each module (control module 12, docking module 16, or brain module 26) includes a housing 20 having physical features 30 for mechanically connecting the module (12, 16, 26) with another module (12, 16, 26). In the illustrative embodiment, the module housing 20 includes tongue and groove joints 30: two grooves 30A in the upper side of the module 12, two tongues 30B in the lower side of the module 12, one groove 30A in the left side of the module 12, and one tongue 30B in the right side of the module 12. Thus, the tongue 30B in the right side of a first module 12A can fit into the groove 30A of a second module 12B, and the tongues 30B in the lower side of a third module 12C can fit into the grooves 30A in the upper side of the second module 12B (as shown in the illustrative configuration of FIG. 1). The tongue and groove features 30 may also include catches or similar mechanisms for securely locking the modules 12 in place.

Each module (12, 16, 26) also includes electrical connectors 32 for transferring power and data between adjacent modules (12, 16, 26). As shown in the illustrative embodiment of FIG. 2, the electrical connectors 32 are located in the tongue 30B and groove 30A joints of the module housing 20. Internal wiring in the module (12, 16, 26) couples electrical signals between the electrical connectors 32.

In a preferred embodiment, each module (control module 12, docking module 16, or brain module 26) has similar dimensions, allowing the modules to be easily connected in a variety of configurations. FIG. 1 showed an illustrative horizontal configuration.

FIG. 5 is a top view of modular controller system 10 designed in accordance with an illustrative embodiment of the present teachings, showing an illustrative vertical configuration. In this example, the system 10 includes a docking module 16A, a control module 12D with a two-octave mini-keyboard, a drum pad module 12B, and a control module 12E with a pad bank, connected vertically in a single column. The control modules 12 are connected together via their tongue and groove joints as described above, while the docking module 16A is attached to the keyboard module 12D via a hinge apparatus 34 that allows for articulation.

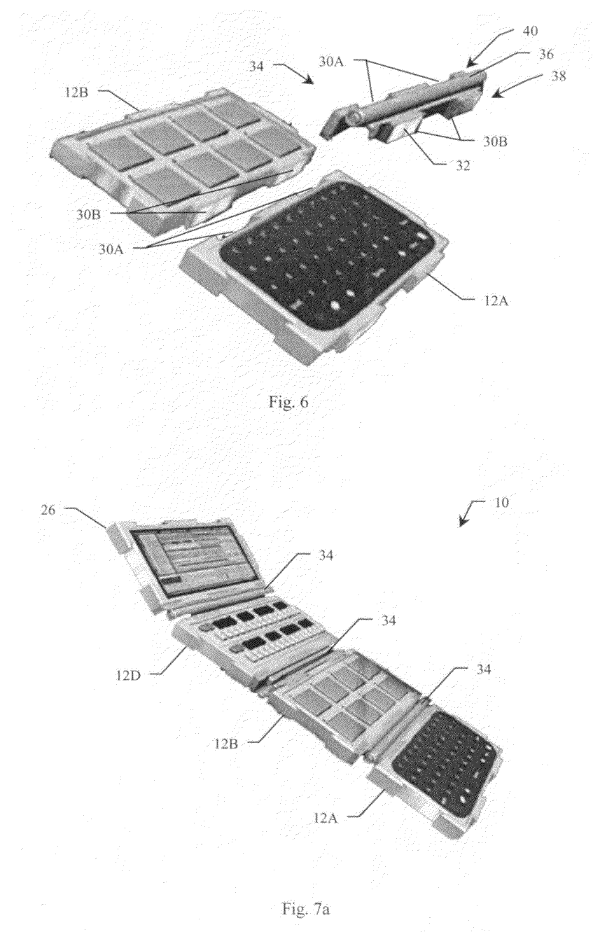

FIG. 6 is an exploded view showing two modules 12A and 12B and a hinge apparatus 34 designed in accordance with an illustrative embodiment of the present teachings. The hinge apparatus 34 is adapted to join two modules via the tongue and groove joints 30. In the illustrative embodiment, the hinge apparatus 34 includes a hinge 36 with a first side 38 having two tongues 30B adapted to fit in the grooves 30A in the upper side of module 12A, and a second side 40 having two grooves 30A adapted to fit with the tongues 30B in the lower side of module 12B. The hinge apparatus 34 also includes electrical connectors 32 in the tongues 30B and grooves 30A for transferring data and/or electrical power between the connected modules. The hinge apparatus 34 allows the controller system 10 to be articulated as desired, and also allows the system 10 to be folded into a compact shape suitable for transport.

A hinge apparatus 34 may also be adapted to connect different sized modules 12. For example, a control module 12 for a compact, portable system 10 may be used in a full sized modular controller system (such as described in the above-identified parent application) by using a hinge that includes a first side having features adapted to connect to features on the full sized system, and a second side having features adapted to connect to features 30 on the portable module 12.

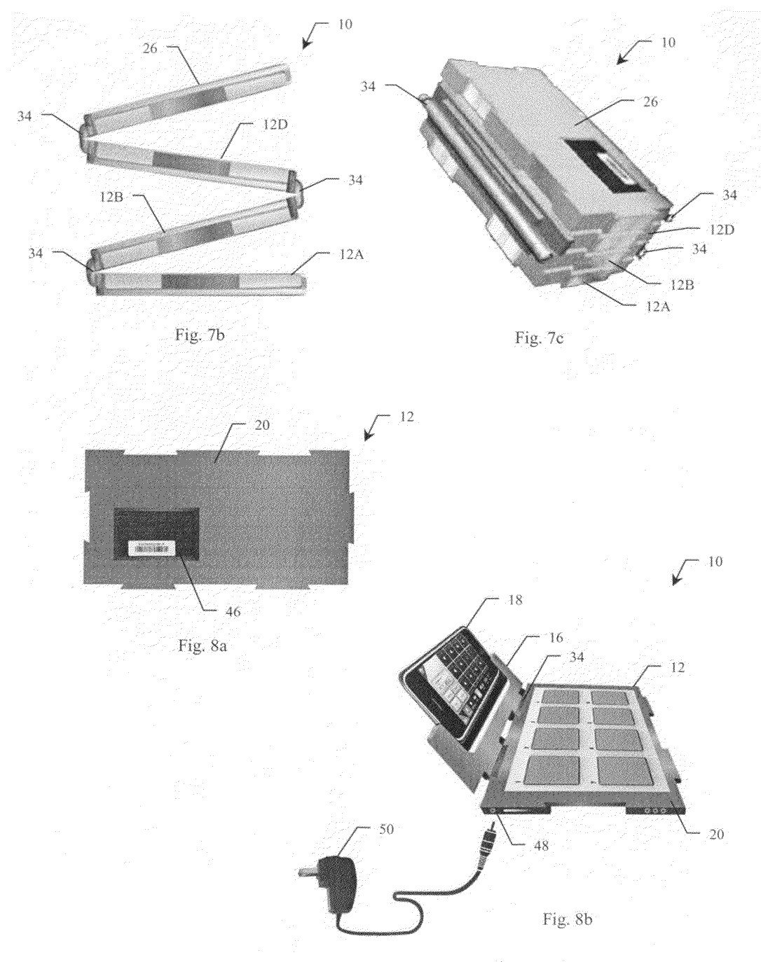

FIG. 7a is an isometric view of a modular controller system 10 designed in accordance with an illustrative embodiment of the present teachings, showing an illustrative vertical configuration connected via hinges. FIG. 7b shows a side view of the system 10 of FIG. 7a and FIG. 7c shows the system 10 of FIG. 7a closed and folded into a compact, pocket-sized shape.

In an illustrative embodiment, each module (control module 12, docking module 16, or brain module 26) may include a rechargeable battery for supplying power to the module, so the unit can operate without being attached to an external power source. In a preferred embodiment, all of the batteries in connected modules may be charged simultaneously by a single wall charger or dedicated battery pack through the electrical connectors 32.

FIG. 8a is a back view of a control module 12 designed in accordance with an illustrative embodiment of the present teachings, showing the back of each module 12 which includes access to a rechargeable battery 46. FIG. 8b is a side view of a controller system 10 designed in accordance with an illustrative embodiment of the present teachings, showing an electrical connector 48 in a side of a module 12 for coupling the system 10 to a wall charger 50. In this embodiment, coupling a single wall charger 50 to one of the modules 12 can charge the batteries 46 in all connected modules (12, 16, 26) via the internal wiring and electrical connectors 32 of the modules 12.

The controller system 10 can also be powered or charged via a USB (Universal Serial Bus) connection. In a preferred embodiment, the electrical connectors 32 on the modules 12 each include a USB connector for transferring data and/or power.

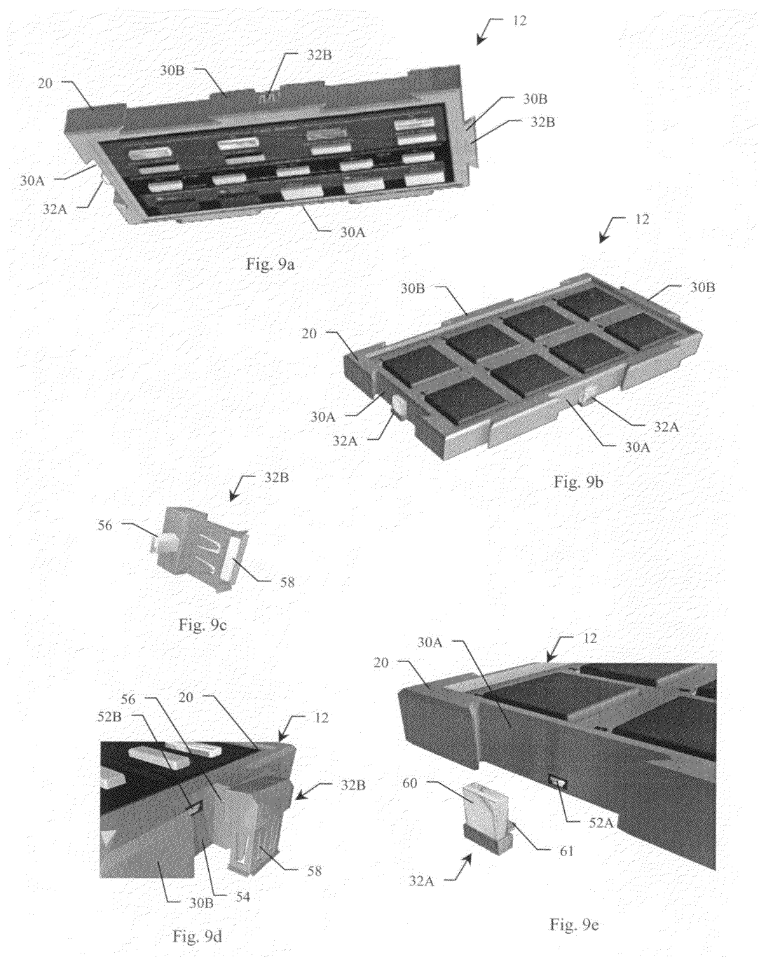

FIGS. 9a and 9b are different isometric views of a control module 12 with USB connectors 32A and 32B designed in accordance with an illustrative embodiment of the present teachings. In this embodiment, the electrical connectors 32 for electrically connecting the modules 12 are implemented using USB connectors 32A and 32B. In the illustrative example, the upper and right sides of each module 12 each include a tongue feature 30B that includes an embedded USB receptacle 32B (most clearly shown in FIG. 9a). The lower and left sides of the module 12 each include a groove feature 30A that includes a USB plug 32A, such that when two modules 12 are physically connected via a tongue 30B and groove 30A, the respective USB receptacle 32B is connected to the respective USB plug 32A.

In a preferred embodiment, the USB connectors 32A and 32B are detachable from the module 12. FIG. 9c is an isometric view of a detachable USB connector 32B designed in accordance with an illustrative embodiment of the present teachings. FIG. 9d shows a close up view of a module 12 with a detachable USB connector 32B and FIG. 9e shows a close up view of a module 12 with a detachable USB connector 32A. The modules 12 include USB receptacles 52 within the tongue 30B (shown in FIG. 9d) and groove 30A (shown in FIG. 9e) features. In the illustrative example, a mini-A type USB receptacle 52B is positioned near the top of the module 12 in the tongue 30B, while a mini-B type USB receptacle 52A is positioned near the bottom of the module 12 in the groove 30A. A cutout 54 is provided within the tongue feature 30B for receiving the USB connector 32B.

As shown in FIG. 9c, the USB connector 32B includes a mini-A type USB plug 56 for coupling with the mini-A receptacle 52B on the module 12, and a type A USB receptacle 58 for coupling with a type A USB plug 60 on the connector 32B. As shown in FIG. 9e, the USB connector 32A includes a mini-B type USB plug 61 for coupling with the mini-B receptacle 52A on the module 12, and a type A USB plug 60 for coupling with the type A USB receptacle 58 on the connector 32B. In this embodiment, the hinge apparatus 34 would similarly be equipped with USB connectors (which could be detachable or integrated into the hinge apparatus 34) for coupling with the USB connectors 32A and 32B on the modules 12.

In the embodiment of FIGS. 9a-9e, power may be provided to the system 10 via the USB ports. For example, power may be supplied by connecting a module 12 to a computer or a USB wall charger equipped with a USB port using a USB cable (the cable may be connected to either the USB receptacle 52A or 52B in the module 12 or the detachable USB connector 32A or 32B, depending on the type of cable used). As with the wall charger 50 described above, a single USB connection can power all connected modules 12. The USB ports may also be used to transfer data between the modules 12 and a computer or other USB device.

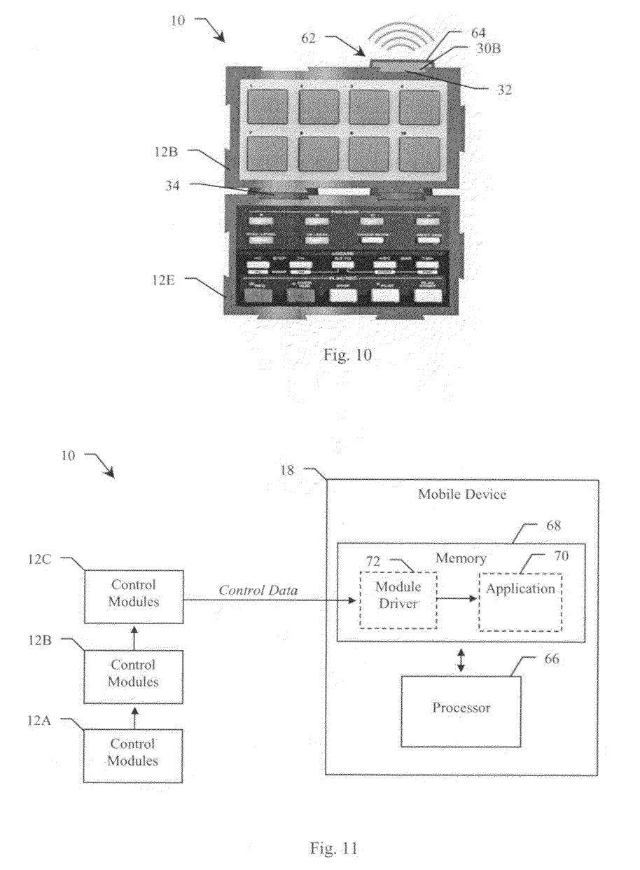

Data may also be transferred via a wireless network. FIG. 10 is a top view of a modular controller system 10 with a wireless network adapter 62 designed in accordance with an illustrative embodiment of the present teachings. The wireless adapter 62 is a separate device having a transceiver for communicating between control modules 12 and an external primary device such as a desktop or laptop computer, cellular phone, or video game console, etc. The wireless network adapter 62 can communicate using any suitable communication protocol such as Wi-Fi or Bluetooth. The wireless adapter 62 includes a housing 64 having a tongue feature 30B adapted to fit in a groove 30A of a module 12 and having an electrical connector 32 adapted to connect with the electrical connector 32 in the groove 30A of the module 12. Data from all connected modules 12 can be transmitted via a single wireless adapter 62 that is connected to one of the connected modules 12. Alternatively, one or modules 12 may include a built-in wireless transceiver for communicating data with a primary device or between modules 12.

In operation, a wide variety of control modules 12 with different types of controls 14 is available to the user. The user selects which control modules 12 he would like to use and physically connects them together as desired using the tongue and groove features 30 on the modules 12 and optional hinge apparatuses 34. In the preferred embodiment, physically connecting the modules 12 in this manner also establishes electrical connections between the modules 12 via the electrical connectors 32 in the tongue and groove features 30.

The group of control modules 12 is then coupled to a primary device. The primary device may be physically connected to one (or more) of the control modules 12 by using a docking module 16, which connects a mobile device 18 to the control modules 12, or a brain module 26. Alternatively, the group of control modules 12 may use a wireless network adapter 64 or a USB module 52 to communicate with a remote primary device such as a computer.

FIG. 11 is a simplified block diagram of a modular controller system 10 designed in accordance with an illustrative embodiment of the present teachings. In this example, three control modules 12A, 12B, and 12C are connected together and coupled to a primary device 18, which in the preferred embodiment is a cellular phone. The primary device 18 includes a processor 66 and memory 68, and may include an audio editing program or other application software 70 stored in the memory 68 and executed by the processor 66. In accordance with the present teachings, the mobile device 18 also includes driver software 72, stored in the device memory 68 and executed by the device processor 66, for receiving and decoding the data from the control modules 12.

In an illustrative embodiment, each control module 12 outputs data that includes digital messages for indicating when a particular control 14 on that module 12 is activated, deactivated, or changed, along with any associated parameters. For example, a digital message output by a module 12 may include a module identifier, a control number (or other control identifier), and one or more parameters associated with the control 14, such as “MODULE A, CONTROL 10, INTENSITY=85”.

The data output from each control module 12 is passed through each connected control module 12 until it reaches the primary device 18. Each module 12 is therefore adapted to receive the control data from the previous module 12 (if applicable), merge the previous control data with its own control data, and output the combined data to the next module 12 (or to the primary device 18). For example, in the illustrative embodiment shown in FIG. 11, control module 12B receives the control data generated by module 12A and outputs data including the data from both modules 12A and 12B, which is output to module 12C. Module 12C then outputs data from all three modules 12A, 12B, and 12C to the primary device 18.

The module driver 72 in the primary device 18 receives the data from the control modules 12 and outputs corresponding data to the application 70 in a format which the application 70 understands. For example, if the application 70 has been designed to use MIDI commands, the module driver 72 encodes the data in a MIDI format and outputs the MIDI data to the application 70.

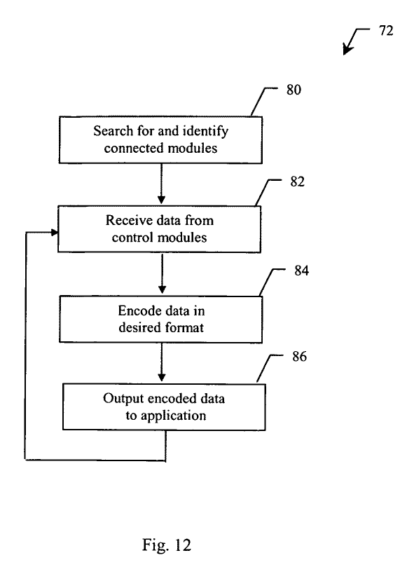

FIG. 12 is a simplified flow chart of a module driver 72 designed in accordance with an illustrative embodiment of the present teachings. First at Step 80, after the control modules 12 are coupled to the primary device 18, the driver 72 searches for and identifies the connected modules 12. In an illustrative embodiment, each control module 12 sends a digital message identifying the module 12 and including information such as the number of controls 14 in the module 12 and the type or types of messages (e.g., note on/off messages or general control messages) the module 12 generates.

The driver 72 is then ready to receive data. During normal operation, the user acts on the various controls 14 of the control modules 12, generating control data that is passed through the connected modules 12 to the primary device 18. At Step 82, the driver 72 receives the data from the control modules 12. At Step 84, the driver 72 encodes the data in a format that can be understood by the application 70. At Step 86, the encoded data is output to the application 70. The application 70 can then use that data to perform various functions. Steps 82-86 are repeated continuously, monitoring the movements and positions of all controls 14 in all the modules 12 until the user is finished.

Thus, the present invention has been described herein with reference to a particular embodiment for a particular application. Those having ordinary skill in the art and access to the present teachings will recognize additional modifications, applications and embodiments within the scope thereof. For example, while the invention has been described with reference to MIDI and audio applications, the novel modular controller system may also be adapted to control other types of applications that might benefit from external or auxiliary controls such as video editing, stage and lighting effects, surveillance camera control, video games, remote entertainment system control, etc., and the control modules may include other types of controls used for these applications such as video game controllers.

It is therefore intended by the appended claims to cover any and all such applications, modifications and embodiments within the scope of the present invention.

Accordingly,

What is claimed is:

1. A modular controller system comprising:
a plurality of control modules, each module including a plurality of controls;
first means for mechanically connecting said modules;
second means for communicating data from said control modules to a mobile device; and
third means operable by said mobile device for receiving said data from said control modules and in accordance therewith generating output data.

2. The invention of claim 1 wherein said first means includes physical features on each module adapted to connect with mating features on another module.

3. The invention of claim 2 wherein said first means includes tongue and groove features in a housing of each module.

4. The invention of claim 2 wherein said second means includes electrical connectors for transferring data between modules.

5. The invention of claim 4 wherein said first means further includes a hinge apparatus for connecting two modules via said physical features.

6. The invention of claim 5 wherein said hinge apparatus includes electrical connectors for connecting with said electrical connectors on said modules to transfer data between modules through said hinge apparatus.

7. The invention of claim 4 wherein said electrical connectors include USB connectors in said physical features.

8. The invention of claim 7 wherein said electrical connectors include a USB receptacle in each module and a detachable USB connector apparatus having a USB plug adapted to connect to said receptacle in said module and a USB connector adapted to connect with a mating USB connector in another connector apparatus.

9. The invention of claim 2 wherein said second means includes a docking module for holding and interfacing with said mobile device.

10. The invention of claim 9 wherein said docking module includes physical features adapted to connect to said physical features on said control modules.

11. The invention of claim 10 wherein said docking module includes electrical connectors for transferring data from said control modules to said mobile device.

12. The invention of claim 1 wherein said third means includes a program stored in and executed by said mobile device.

13. The invention of claim 1 wherein said third means generates output data for controlling an application running on said mobile device.

14. The invention of claim 1 wherein said mobile device is a cellular phone.

15. The invention of claim 1 wherein said controls include MIDI controls.

16. A modular controller system comprising:
a plurality of control modules, each module including a plurality of controls and adapted to generate control messages in response to user actions on said controls, wherein each module includes a housing having physical features for mechanically connecting said modules; and
a program stored in and executed by a mobile device for receiving said control messages from said control modules and in accordance therewith generating output data for controlling an application running on said mobile device.

17. A computer implemented method for controlling an application on a mobile device including the steps of:
receiving control messages from a plurality of control modules and
generating output data in response to said control messages for controlling said application running on said mobile device.

18. A method for controlling an application on a mobile device including the steps of
providing a plurality of control modules, each module including a plurality of controls and adapted to generate control messages in response to user actions on said controls, wherein each module includes a housing having physical features for mechanically connecting said modules;
connecting said control modules together via said physical features;
communicating said control messages from said control modules to a mobile device; and
receiving said control messages and in accordance therewith generating output data for controlling an application running on said mobile device.
